(19) United States
(12) Patent Application Publication
(10) Pub. No.: US 2024/0080367 A1
(43) Pub. Date: Mar. 7, 2024

(54) Automatic Execution of Web Flows

(71) Applicant: Synchronoss Technologies, Inc., Bridgewater, NJ (US)

(72) Inventor: Ian McLellan, Maidenhead (GB)

(21) Appl. No.: 18/269,495

(22) PCT Filed: Dec. 30, 2021
(86) PCT No.: PCT/US21/65800

§ 371 Date: Jun. 23, 2023

Related U.S. Application Data
(60) Provisional application No. 63/132,096, filed on Dec. 30, 2020.

(51) Int. Cl. H04L 67/14; H04L 67/02

(52) U.S. Cl. CPC H04L 67/14; H04L 67/02

(57) ABSTRACT

Systems, methods, devices, and non-transitory computer-readable media for automatic web flow execution are described. The disclosed technology may access flow model data comprising information associated with steps of a web flow. Based on the flow model data, the steps of the web flow may be mapped to application programming interface (API) interactions with a client computing device. Requests may be received from a first client computing device during a session associated with the of the web flow. The requests may be based at least in part on the API interactions. Resources associated with the requests may be accessed. State data associated with the resources requested by the first client computing device during the web flow may be updated. Furthermore, responses comprising links associated with execution of at least one of the one or more steps of the web flow may be sent to the first client computing device.

### CROSS-REFERENCE TO RELATED APPLICATIONS

This application claims the benefit of priority to U.S. Provisional Application No. 63/132,096, filed Dec. 30, 2020 and entitled “An Executable Model and Client-Server System For The Automation of HTTP-Based Web Flows,” the entirety of which is incorporated by reference herein for all purposes.

### FIELD OF USE

Aspects of the disclosure relate generally to the automatic execution of web flows. More specifically, aspects of the disclosure provide for using a flow model to generate an executable web flow including steps that are executed by a server computing system in communication with a client computing device.

### BACKGROUND

A web flow may include a set of interactions between a user and a user interface of a client computing device. In particular, the web flow may be associated with some particular task that a user is attempting to accomplish through the set of interactions. For example, a web flow for a user searching for a new smartphone plan may include selecting smartphone plan, selecting an accompanying smartphone, then purchasing the plan and smartphone using payment options associated with the user. Designing a web flow may require careful planning and testing. To ensure that the web flow operates properly on different devices, it may be necessary to individually tailor a web flow to the idiosyncrasies of each client computing device and/or user interface. As such, the development of web flow for a variety of devices may require a burdensome investment in time and resources that results from having to configure and test the web flow on a wide variety of devices.

Additionally, when a web flow is updated, such as when steps are added or removed from the web flow, the process of configuring and testing the web flow may begin anew with the concomitant expenditure of time and resources. As such, there exists a need for a way to execute the steps of a web flow in a more platform agnostic manner such that execution of the web flow is not tied to individual client computing devices or user interfaces.

### SUMMARY

The following summary presents a simplified form of various aspects described herein. This summary is not a comprehensive overview of the subject matter in the detailed description nor does this summary limit the scope of the claims presented herein.

Aspects described herein are generally directed to the automatic execution of web flows. These aspects may improve the effectiveness with which web flows may be executed by offering an automatic method to execute flow models on a server computing device in communication with a client computing device.

Aspects described herein may allow for automatic methods, devices, systems, apparatuses, and/or non-transitory computer-readable media for automatically executing web flows. Through novel implementations of sophisticated modelling and web flow techniques, the aspects described herein allow for the execution of web flows on a variety of client computing devices. The use of such techniques may provide a host of technical effects and/or benefits including the automatic mapping of one or more steps of a flow model to Application Programming Interface (API) interactions with a client computing device or a control element of a user interface. According to some aspects, these and other technical effects and benefits may be achieved by using the mapped web flow to execute a session based on the steps of the web flow that is performed by a server computing device and a client computing device. In this way a web flow may be created in a relatively simple flow model that is then automatically mapped to the appropriate API interaction associated with the client computing device and/or a control element of the user interface and then executed by the disclosed technology. Furthermore, the disclosed technology may validate the steps of the web flow by using an API policy that is enforced by the server computing device.

More particularly, some aspects described herein may provide a computer-implemented method for automatic execution of web flows. The method may comprise accessing, by a server computing device, flow model data comprising information associated with one or more steps of a web flow. The method may further comprise mapping, by the server computing device, based at least in part on the flow model data, the one or more steps of the web flow to one or more Application Programming Interface (API) interactions with a client computing device and/or one or more control elements. The method may also comprise receiving, by the server computing device from a first client computing device, one or more requests during a session associated with the one or more steps of the web flow. The one or more requests may be based at least in part on the one or more API interactions. The method may also include accessing, by the server computing device, one or more resources associated with the one or more requests. The method may include updating, by the server computing device, state data associated with the one or more resources used by the first client computing device during the web flow. Furthermore, the method may comprise sending, by the server computing device to the first client computing device, one or more responses. The one or more responses may comprise one or more links associated with execution of at least one of the one or more steps of the web flow. Further, the one or more links may comprise one or more resource links to one or more resources.

Further, the method may comprise validating, by the server computing device, the one or more steps of the web flow based at least in part on an API policy. Validating the one or more steps of the web flow may comprise determining, by the server computing device, whether each of the one or more steps of the web flow is in an order that is in accordance with a flow order set forth by the API policy.

The method may comprise determining, by the server computing device, one or more dependencies associated with one or more resources that are accessed when the one or more steps are executed. Further, the method may comprise modifying, by the server computing device, the one or more dependencies when there is a change in the one or more resources corresponding to the one or more dependencies. Modifying the one or more dependencies comprises adding one or more dependencies when the one or more resources corresponding to the one or more dependencies are added or deleting one or more dependencies when the one or more resources corresponding to the one or more dependencies are deleted.

The one or more interactions may comprise an interaction with the one or more links that request execution of a first step of the one or more steps, and wherein the first step comprises at least one of: a request to end the session or a request to perform another step. Further, the one or more API interactions may comprise one or more control element interactions of a user interface of the first client computing device. Further, the one or more API interaction may comprise at least one of: execution of a business rule, calling an API function, or communicating with a remote computing device. Further, the one or more API interaction associated with the one or more control elements may comprise one or more exclusive choice element interactions or one or more multiple choice element interactions.

The web flow may be associated with navigation of one or more web pages via a user interface implemented by the client computing device. The one or more steps of the web flow may be arranged in a linear flow in which each step of the web flow is associated with one or more steps defined by the flow model data, and wherein the one or more steps are in accordance with an API policy. The execution of the one or more steps of the web flow may be initiated by the server computing device in response to receiving request to initiate a web flow session from the first client computing device. The web flow may be implemented via a web application, and wherein the one or more steps are associated with accessing resources via the web application.

The one or more requests may comprise at least one of: a request to advance to a next step of the web flow, a request to update the state of the one or more resources used in a previous step of the web flow, a request to update the state of the one or more resources used in a previous step of the web flow, or a request to retrieve the state of one or more resources that were used in a previous step of the web flow.

The state data may comprise information associated with a control state or an extended state. The control state may be associated with one or more resources generated by the first client computing device during the web flow. The extended state may be associated with data submitted by the first client computing device or retrieved from a remote computing device based on an API interaction by the first client computing device.

The one or more steps of the web flow be executed until an end condition associated with ending the web flow is satisfied. Satisfying the end condition comprises the client computing device sending a request to end the web flow, a predetermined amount of time elapsing without the server computing device receiving a request from the client computing device, or the execution of a final step of the one or more steps of the web flow.

More particularly, some aspects described herein may provide one or more non-transitory computer readable media comprising instructions that, when executed by at least one processor, cause a computing device to perform operations comprising: accessing flow model data comprising information associated with one or more steps of a web flow. The operations may further comprise mapping, based at least in part on the flow model data, the one or more steps of the web flow to one or more Application Programming Interface (API) interactions with a client computing device and/or one or more control elements. The operations may also comprise receiving from a first client computing device, one or more requests during a session associated with the one or more steps of the web flow. The one or more requests may be based at least in part on the one or more API interactions. The operations may also include accessing one or more resources associated with the one or more requests. The operations may include updating state data associated with the one or more resources used by the first client computing device during the web flow. Furthermore, the operations may comprise sending, to the first client computing device, one or more responses. The one or more responses may comprise one or more links associated with execution of at least one of the one or more steps of the web flow.

More particularly, some aspects described herein may provide a computing device comprising: one or more processors; and memory storing instructions that, when executed by the one or more processors, cause the computing device to access flow model data comprising information associated with one or more steps of a web flow. The instructions, when executed by the one or more processors, may cause the computing device to map, based at least in part on the flow model data, the one or more steps of the web flow to one or more Application Programming Interface (API) interactions with a client computing device and/or one or more control elements. The instructions, when executed by the one or more processors, may cause the computing device to receive from a first client computing device, one or more requests during a session associated with the one or more steps of the web flow. The one or more requests may be based at least in part on the one or more API interactions. The instructions, when executed by the one or more processors, may cause the computing device to access one or more resources associated with the one or more requests. The instructions, when executed by the one or more processors, may cause the computing device to may include updating state data associated with the one or more resources used by the first client computing device during the web flow. Furthermore, the instructions, when executed by the one or more processors, may cause the computing device to send, to the first client computing device, one or more responses. The one or more responses may comprise one or more links associated with execution of at least one of the one or more steps of the web flow.

Corresponding apparatuses, devices, systems, and computer-readable media including non-transitory computer-readable media are also within the scope of the disclosure.

These aspects, features, and benefits of various embodiments of the present disclosure along with many others, are discussed in greater detail below.

### BRIEF DESCRIPTION OF THE DRAWINGS

The present disclosure is illustrated by way of example and not limited in the accompanying figures that are referenced by the specification.

FIG. 1 illustrates an example of a computing system that may be used to implement one or more aspects of the disclosure in accordance with one or more illustrative aspects discussed herein.

FIG. 2 illustrates an example of a computing device that may be used to implement one or more aspects of the disclosure in accordance with one or more illustrative aspects discussed herein.

FIG. 3 illustrates an example of a method for automatically executing a web flow according to one or more aspects of the disclosure.

FIG. 4 illustrates an example of a method for automatically executing a web flow according to one or more aspects of the disclosure.

FIG. 5 illustrates an example of an automatic web flow system according to one or more aspects of the disclosure.

FIG. 6 illustrates an example of a linear web flow according to one or more aspects of the disclosure.

FIG. 7 illustrates an example of a non-linear web flow according to one or more aspects of the disclosure.

FIG. 8 illustrates an example of server computing device interactions with multiple client computing devices according to one or more aspects of the disclosure.

Reference numerals that are used in multiple figures are intended to refer to the same or similar features in various embodiments.

### DETAILED DESCRIPTION

In the following detailed description of various embodiments, reference is made to the accompanying drawings, which form a part of the present disclosure, and in which is shown by way of illustration various embodiments in which aspects of the disclosure may be practiced. It is to be understood that other embodiments may be utilized and structural and functional modifications may be made without departing from the scope of the present disclosure. Aspects of the present disclosure allow for other embodiments that may be practiced or carried out in various ways. Also, it is to be understood that the terminology used herein is for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents.

The automated execution of web flows may involve a significant amount of manual input including customizing the web flow to the requirements of particular devices and/or interfaces. Further, when the web flow is being executed, there may be inefficiencies that result from suboptimal management of any resources involved in executing the steps of the web flow. As such, the execution of web flows may be made more effective by reducing the amount of manual customization, as well as providing better management of resources. For example, the disclosed technology may more efficiently map the steps of a flow model to API interactions with the client computing device and/or API interactions with control elements of a user interface. Further, dependencies on resources that will no longer be used may be reduced which may reduce the computational burden imposed by the task of executing the web flow. The disclosed technology also offers improvements in the validation of web flows to ensure that the web flow is in accordance with an API policy and that the steps of the web flow follow a proper sequence. To improve the execution of web flows based on flow model data and achieve these benefits (e.g., more efficient use of computing resources resulting from better management of dependencies on unused resources) that may be realized through better web flow mapping and updating of state data. In particular, aspects discussed herein may relate to methods, devices, systems, apparatuses, non-transitory computer readable media, and techniques for executing web flows.

A computing device implementing the disclosed technology may access flow model data. The flow model data may include steps that may be visualized in the form of a graph with nodes that represent the steps and edges that determine the sequence the web flow is executed in. The computing device may then map the steps of the flow to API interactions with a client computing device (e.g., interactions by the API without user intervention) and/or one or more control elements (e.g., control elements of a user interface that are activated by a user of the client computing device). A session may then be executed such that communication is established between a server computing device and a client computing device. The session may include the receipt of requests from the client computing device. For example, the requests may include an initial request to start the session followed by requests associated with API interactions originating from the client computing device. The server computing device may then use resources based on the requests from the client computing device. For example, when the client computing device requests an advancement to the next step of the web flow, the server computing device may use the resources necessary to fulfill the request. State data including the current state of the web flow and historical states of the web flow may be updated when resources are used. Further, the server computing device can send responses to the client computing device. The responses may include links associated with execution of at least one of the steps of the web flow.

In this way, the effectiveness with which a web flow is executed may be improved. As discussed herein, this combination of features may allow for improvements in mapping the steps of a web flow and executing a session associated with the steps of the web flow.

With reference to the figures, example embodiments of the present disclosure will now be discussed in greater detail.

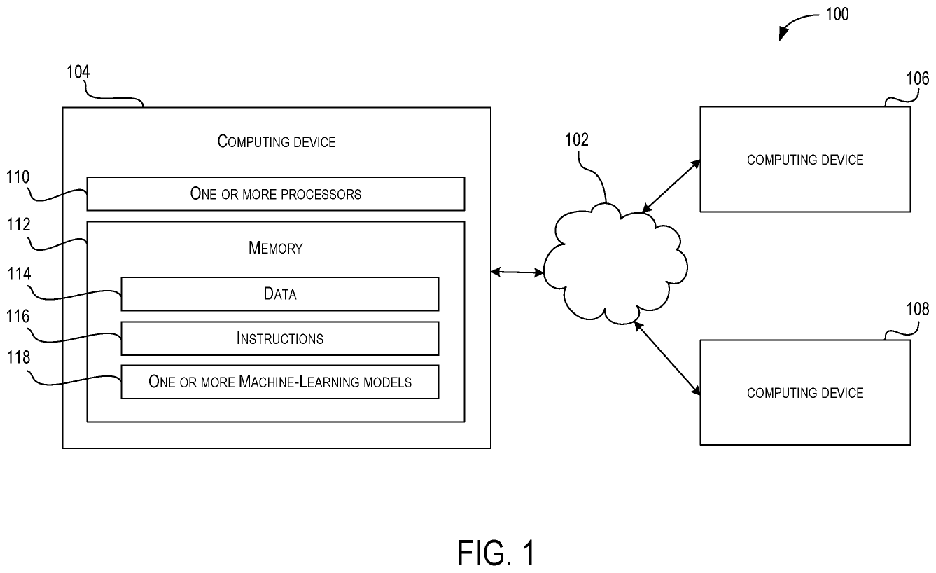

FIG. 1 illustrates an example of a computing system 100 that may be used to implement one or more aspects of the present disclosure discussed herein. In particular, FIG. 1 depicts a diagram of a computing system that is configured to perform operations associated with the generation of tag data. As illustrated in FIG. 1, the computing system 100 includes computing device 104 (e.g., a server computing device), computing device 106 (e.g., a client computing device), and computing device 108 (e.g., a client computing device) interconnected via network 102. As shown in FIG. 1, the computing device 104 may comprise one or more processors 110 and memory 112. The memory 112 may store data 114 and/or instructions 116. The computing system 100 may operate in a standalone environment. In some embodiments, the computing system 100 may operate as part of a networked environment. For example, the computing system 100 may operate in conjunction with other computing systems and/or other computing devices not shown in FIG. 1.

The network 102 may include any type of network and may be used to communicate signals, information, and/or data. The network 102 may include any combination of wired and/or wireless networks and may carry any type of signal or communication including communications and/or signals using one or more communication protocols (e.g., TCP/IP, Ethernet, FTP, HTTP, HTTPS, and the like) and/or one or more wireless communication technologies (e.g., GSM, CDMA, Wi-Fi, LTE, 5G, etc.). The network 102 may for example include a local area network (LAN), an intranet, a wide area network (WAN), and/or the Internet. Furthermore, the network 102 may be configured or arranged according to any known topology and/or architecture.

The computing device 104 may, in some embodiments, implement one or more aspects of the present disclosure by accessing and/or executing instructions; and/or performing one or more operations based at least in part on the instructions. In some embodiments, the computing system 100 may be incorporated into and/or include any type of computing device (e.g., a computing device with one or more processors, one or more memory devices, one or more input devices, and/or one or more output devices). By way of example, the computing device 104 may be incorporated into and/or include a desktop computer, a computer server, a computer client, a mobile device (e.g., a laptop computer, a tablet computer, a smart phone, and/or a smart watch), and/or any other type of processing device. Further, the computing device 104 may be a server computing device that executes one or more of the operations described herein including the operations associated with accessing the flow model data 206, accessing the state data 208, mapping one or more steps of a web flow to one or more interactions, and/or executing a session between the computing device 104 and one or more client devices (e.g., the computing device 106 and/or the computing device 108).

The computing device 104 may include one or more interconnects for communication between different components of the computing device. The computing device 104 may also include a network interface via which the computing device 104 may exchange one or more signals including information and/or data with other computing systems and/or computing devices. For example, the computing device 104 may send information and/or data to the computing device 106 via the network 102. By way of further example, the computing device 104 may receive information and/or data from the computing device 106 via the network 102. Further, the computing device 104 may include one or more input devices (e.g., a keyboard, mouse, touch screen, stylus, and/or microphone) and/or one or more output devices (e.g., a display device and/or audio output devices including loudspeakers).

As seen in FIG. 1, computing device 104 may include one or more processors 110 and a memory 112. The one or more processors may include any combination of processing devices (e.g., one or more computer processing units (CPUs), one or more graphics processing units (GPUs), one or more processor cores, one or more microprocessors, one or more application specific integrated circuits (ASICs), one or more field programmable gate arrays (FPGAs), and/or one or more controllers). Further, the one or more processors 110 may be arranged in different configurations including as a set of serial processors or parallel processors.

The memory 112 may include one or more computer-readable media (e.g., non-transitory computer-readable media) and may be configured to store data and/or instructions including the data 114 and/or the instructions 116. By way of example, the memory 112 may include one or more memory devices including random access memory (RAM), read only memory (ROM), programmable read only memory (PROM), erasable programmable read only memory (EPROM), electrically erasable programmable read only memory (EEPROM), solid state drives (SSDs), hard disk drives (HDDs), and/or hybrid memory devices that use a combination of different memory technologies.

The computing device 106 and/or the computing device 108 may include one or more processors with the features and/or capabilities of the one or more processors 110, a memory with the features and/or capabilities of the memory 112, one or more network interfaces, one or more mass storage devices, one or more input and output interfaces, one or more input devices, and/or one or more output devices. Further, the computing device 106 and/or the computing device 108 may operate as client devices with respect to the computing device 104.

Further, the computing device 106 and/or the computing device 108 may have different or similar configurations and/or architectures to that of the computing device 104. Furthermore, any combination of the computing device 104, the computing device 106, and/or the computing device 108 may operate separately and/or together. For example, performance of operations may be distributed among the computing device 104 and the computing device 106.

One or more aspects discussed herein may be embodied in computer-usable, computer-readable data, and/or computer-executable instructions, which may be stored as data and/or instructions in one or more memory devices and/or executed by one or more computing devices or other devices as described herein. Generally, the data and/or instructions may include software applications, routines, computing programs, functions, objects, components, data structures, and the like that may perform particular tasks or implement particular abstract data types when executed by one or more processors in a computing device or other device. The data and/or instructions be written in a source code programming language that is subsequently compiled for execution, or may be written in a scripting language including (but not limited to) Python, Perl, or any other suitable scripting language. The computer executable instructions may be stored on a computer readable medium (e.g., a non-transitory computer-readable medium) such as a hard disk, solid state drive, optical disk, removable storage media, solid state memory, RAM, etc. As will be appreciated by a person having skill in the art, the functionality of the computing applications described herein may be combined or distributed in various embodiments. Further, the functionality may be embodied partly or wholly in firmware or hardware equivalents including integrated circuits, field programmable gate arrays (FPGA), and the like. Particular data structures may be used to more effectively implement one or more aspects discussed herein, and such data structures are contemplated within the scope of computer executable instructions and computer-usable data described herein.

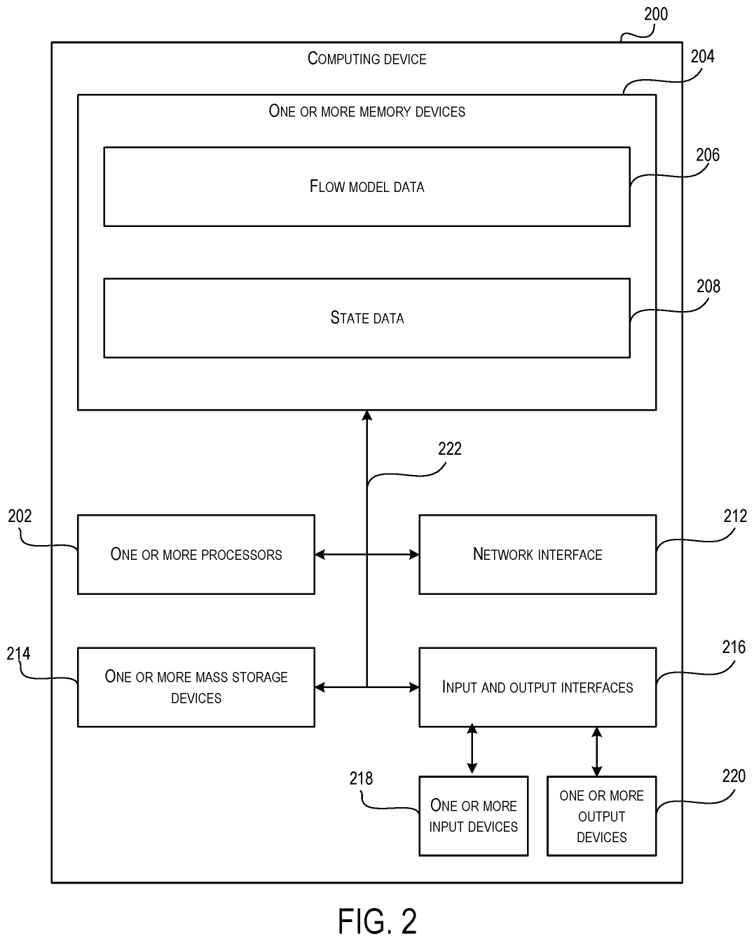

Any of the devices and systems described herein may be implemented, in whole or in part, using one or more computing devices described with respect to FIG. 2. FIG. 2 illustrates one example of a computing device 200 that may be used to implement one or more illustrative aspects discussed herein. For example, the computing device 200 may, in some embodiments, implement one or more aspects of the present disclosure. Further, the computing device 200 may include any of the features and/or capabilities of the computing system 101 that is illustrated in FIG. 1.

The computing device 200, may include one or more processors 202, one or more memory devices 204, a network interface 212, one or more mass storage devices 214, input and output interfaces 216, one or more input devices 218, one or more output devices 220, and/or one or more interconnects 222. The one or more memory devices may store flow model data 206 and/or state data 208. The computing device 200 is not limited to the configuration depicted in FIG. 2 and may include any number of processors, memory devices, mass storage devices, input and output interfaces, interconnects, and/or network interfaces. Further, any of the processors, memory devices, mass storage devices, input and output interfaces, interconnects, and/or network interfaces may be provided as any combination of separate components and/or as parts of the same component.

The one or more processors 202 may include one or more computer processors that are configured to execute one or more instructions stored in the one or more memory devices 204. The one or more processors 202 may include one or more general purpose central processing units, one or more application specific integrated circuits (ASICs), and/or one or more graphics processing units (GPUs)), and/or one or more field programmable arrays (FPGAs). Additionally or alternatively, the one or more processors 202 may include single core devices and/or multiple core devices that may include one or more microprocessors, one or more microcontrollers, one or more integrated circuits, and/or one or more logic devices. Furthermore, the one or more processors 202 may perform one or more operations comprising processing the flow model data 206 and/or the state data 208. For example, the one or more processors 202 may perform one or more operations comprising accessing the flow model data 206, mapping one or more steps of the web flow to one or more interactions, and executing a session associated with the steps of the web flow. The session executed by the one or more processors 202 may comprise receiving one or more requests, performing one or more steps of the web flow, updating the state data 208, and sending one or more responses to the client computing device.

The one or more memory devices 204 may store information and/or data (e.g., the flow model data 206 and/or the state data 208). Further, the one or more memory devices 204 may include one or more non-transitory computer readable storage media, including RAM, ROM, EEPROM, flash memory devices, magnetic disks, and/or any of the memory devices described herein (e.g., the memory 112 illustrated in FIG. 1). The information and/or data stored by the one or more memory devices 204 may include instructions to perform one or more operations. Further, the instructions stored by the one or more memory devices 204 may be executed by the one or more processors 202. Execution of the instructions may cause the computing device 200 to perform one or more operations including the one or more operations described herein.

The one or more memory devices 204 and/or the one or more mass storage devices 214 are depicted as separate entities in FIG. 2. However, the one or more memory devices 204 and/or the one or more mass storage devices 214 may occupy different portions of the same memory device. The one or more memory devices 204 and/or the one or more mass storage devices 214 may include one or more computer-readable media that may include but is not limited to non-transitory computer-readable media described above.

The one or more memory devices 204 may store instructions for one or more applications. The one or more applications may include an operating system that may be associated with various software applications and/or data. In some embodiments, the one or more memory devices 204 may store a general-purpose operating system that executes on the computing device 200. Further, the one or more memory devices 204 may store instructions that allow software applications to access data including the flow model data 206 and/or the state data 208.

The software applications that may be executed by the computing device 200 may include applications associated with the computing system 100 that is depicted in FIG. 1. Further, the software applications operated by the computing device 200 may include applications that operate locally and/or applications that are executed remotely (e.g., web applications that are executed on a server computing device with inputs received by the computing device 200 which may operate as a client device).

The flow model data 206 may comprise one or more portions of data (e.g., the data 114) and/or instructions (e.g., the instructions 116) that are stored in the memory 112. Furthermore, the flow model data 206 may include information associated with a flow model that describes one or more steps of a web flow. The flow model data 206 may be represented as a directed graph in which the nodes of the graph are associated with a resource or a control element (e.g., a control element of a user interface).

The state data 208 may comprise one or more portions of data (e.g., the data 114) and/or instructions (e.g., the instructions 116) that are stored in the memory 112. Further, the state data 208 may comprise information associated with a control state and/or an extended state of a web flow. The control state may be associated with one or more resources generated by the client computing device during the web flow and the extended state may be associated with data submitted by the client computing device and/or retrieved from a remote computing device based at least in part on an API interaction by the client computing device.

The one or more interconnects 222 may include one or more interconnects or buses that may be used to send and/or receive one or more signals (e.g., electronic signals) and/or data (e.g., the flow model data 206 and/or the state data 208) to and/or from one or more components of the computing device 200 (e.g., the one or more memory devices 204, the one or more processors 202, the network interface 212, the one or more mass storage devices 214, and/or the input and output interfaces 216). The one or more interconnects 222 may be configured and/or arranged in various ways including as parallel or serial connections. Further, the one or more interconnects 222 may include one or more internal buses to connect the internal components of the computing device 200; and/or one or more external buses to connect the internal components of the computing device 200 to one or more external devices. For example, the one or more interconnects 222 may include different interfaces including ISA, EISA, PCI, PCI Express, Serial ATA, Hyper Transport, and/or other interfaces that may be used to connect components of the computing device 200.

The network interface 212 may support network connections including connections to communicate via one or more networks. The one or more networks to which the computing device 200 is connected via the network interface 212 may include a local area network, a wide area network, and/or the Internet.

The one or more mass storage devices 214 may be used to store data including the flow model data 206 and/or the state data 208. The one or more mass storage devices 214 may include one or more solid state drives (SSDs) and/or one or more hard disk drives (HDDs).

The input and output interfaces 216 may include one or more input interfaces to receive input from the one or more input devices 218 and/or the one or more output devices 220. The one or more input device 218 may be used to provide one or more inputs to the computing device 200. The one or more input devices 218 may include one or more keyboards, one or more mouse devices, one or more touch input devices (e.g., a capacitive touch screen and/or a resistive touch screen), one or more microphones, and/or one or more cameras. The one or more output devices 220 may include one or more visual output devices (e.g., display devices including LCD displays and/or OLED displays) and/or one or more audio output devices (e.g., one or more loudspeakers).

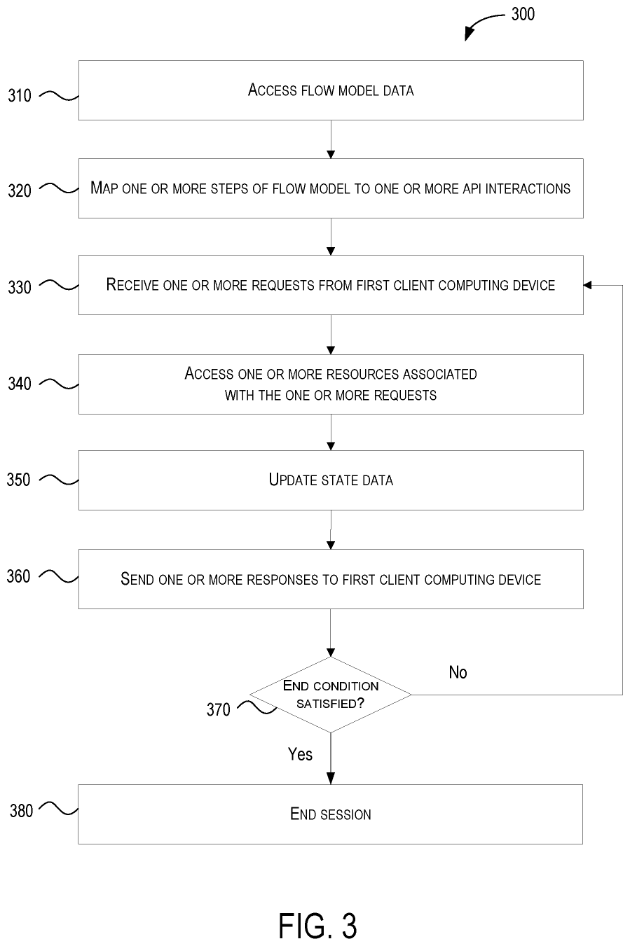

To facilitate the execution of web flows based on a web flow model, the web flow model may be mapped to interactions (e.g., API interactions with the client device and/or API interactions associated with control elements of a user interface) with a client device and the steps of the web flow may be executed based on the mapped interactions. FIG. 3 illustrates an example of a method for automatically executing a web flow according to one or more aspects of the disclosure. The method 300 may be implemented by a computing system and/or computing device including any of the computing systems and/or computing devices described herein. For example, one or more steps and/or one or more portions of the method 300 may be implemented by the computing device 104 that is illustrated in FIG. 1 and/or the computing device 200 that is illustrated in FIG. 2. Further, the method 300 may be implemented in the form of instructions that are executed by a computing system and/or computing device.

At step 310, a computing device (e.g., a server) may access flow model data. The flow model data may comprise information associated with one or more steps of a web flow executed at least in part by the server computing device. For example, the computing device 104 may be a server computing device that accesses flow model data from the memory 112. In some embodiments, the computing device 104 may access the flow model data from another computing system and/or computing device.

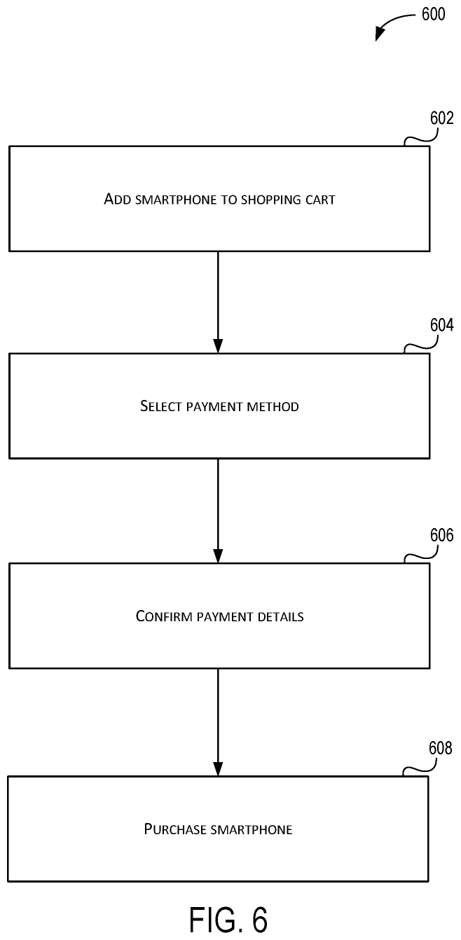

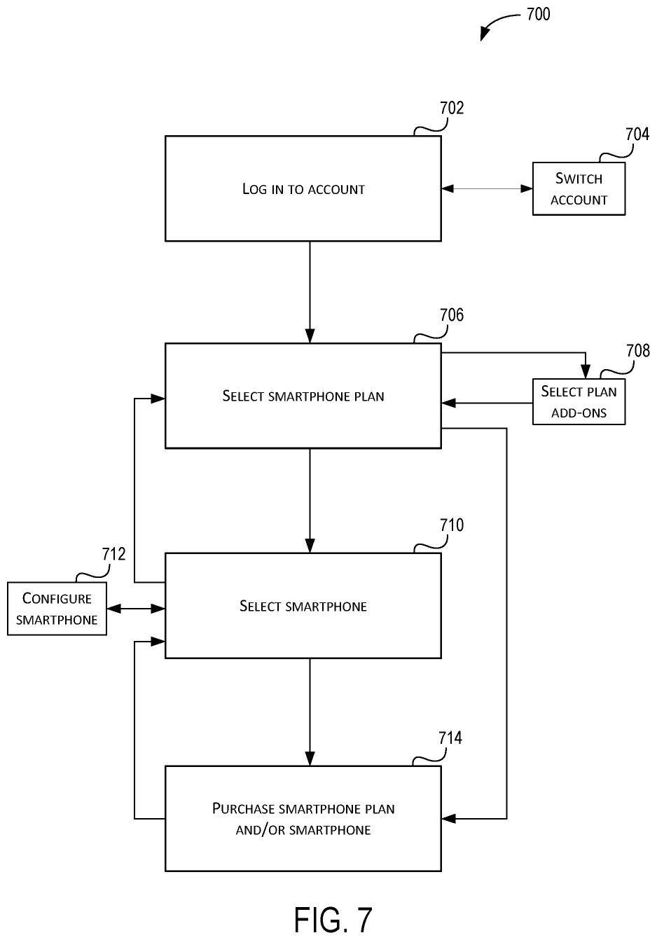

The flow model data may include information and/or data associated with a web flow (e.g., a web flow associated with a customer journey through a website or a mobile application (“app”)) that includes one or more steps that may be executed by a server computing device and provided to a client computing device in the form of one or more links, or pages (e.g., web pages), that can be interacted with via a user interface of the client computing device. The web flow may be associated with navigation of one or more web pages via a user interface implemented by the client computing device. For example, the web flow may be based on navigation of web pages associated with an online store as shown, for example, in FIGS. 6 and 7. Additionally or alternatively, the web flow may be implemented via a web application. Further, the one or more steps of the web flow may be associated with accessing resources via the web application. For example, the web application may include a browser that accesses web pages and/or a stand-alone web application that is used to traverse a specific set of web resources. In some embodiments, the one or more steps of the web flow may follow a linear flow in which each step of the web flow is associated with one or more steps defined by the flow model data. Alternatively, the one or more steps of the web flow may be non-linear and may include one or more cyclic portions including one or more steps that may be performed more than once. Further, the one or more steps may be in accordance with an API policy that may be enforced by the server computing device.

At step 320, the computing device may map the one or more steps of the web flow to one or more API interactions with a client computing device. Mapping the one or more steps of the web flow may be based at least in part on the flow model data. For example, the server computing device may access an API library that may be associated with the web flow model. The server computing device may also access control element information associated with control elements that are associated with one or more functions of the API. The server computing device may then use the API library and/or the control element information to map the steps of the web flow to corresponding interactions by the API or control elements. Furthermore, the one or more interactions may comprise one or more API interactions with the client computing device and/or one or more API interactions with one or more control elements of a user interface. For example, the one or more API interactions may comprise one or more interactions that are associated with at least one control element of a user interface. Further, the one or more API interactions associated with at least one control element of a user interface may comprise an interaction with an exclusive choice element and/or an interaction with multiple choice elements. The interaction with an exclusive choice element may include any interaction in which only one web flow step is presented to the client computing device. The choice on the part of the user controlling the client computing device via the user interface is to perform the interaction with the exclusive choice element or not perform the interaction with the exclusive choice element. The interactions with multiple choice elements may include interactions in which multiple steps of the web flow are presented to the user via the user interface of the client computing device. Alternatively, the one or more API interactions may comprise one or more interactions that are not associated with a control element of a user interface and/or a user's interaction with the user interface.

In some instances, certain API interactions may occur automatically during one or more portions of the web flow. Further, the one or more API interactions with the client computing device may comprise execution of a business rule, calling an API function, or communicating with a remote computing system. For example, the client computing device may call a function associated with adding an item to an online shopping cart. Furthermore, the one or more API interactions may generally be used to access certain resources that are used to complete one or more steps of the web flow.

At step 330, the computing device may access, receive, obtain, and/or retrieve one or more requests during a session associated with the one or more steps of the web flow. The one or more requests may be based at least in part on the one or more API interactions. For example, a client computing device may send a request to initiate a web shopping session to a server computing device, and the server computing device may receive the request to initiate the web shopping session. The web shopping session may be performed on an online store associated with the server computing device. In some embodiments, the one or more requests may comprise a request to advance to the next step in the web flow (e.g., a request to proceed with the next step in a product purchase web flow), a request to update the state of one or more resources used and/or generated in a previous step of the web flow (e.g., a request to remove an item added to the shopping cart in a previous step), a request to update the state of one or more resources used and/or generated in a current step of the web flow (e.g., a request to update a shopping cart with additional items added in the current step of the web flow), and/or a request to retrieve the state of one or more resources used and/or generated in a previous step of the web flow (e.g., a request for a purchase history associated with the previous price of a product in an online shopping cart).

At step 340, the computing device may access one or more resources associated with the one or more requests. Accessing the one or more resources may include retrieving information and/or data from one or more resources, storing information associated with one or more resources, and/or executing one or more operations associated with the one or more resources. For example, in response to a client computing device interaction with a control element associated with displaying the history of a web flow, the server computing device may access state data and provide the history of the web flow to the client computing device. By way of further example, when a request includes adding an item to a shopping cart, the server computing device may store the information and/or data associated with the item in the portion of memory associated with the shopping cart.

At step 350, the computing device may update, modify, and/or adjust state data. The state data may be associated with one or more resources requested by the first client computing device during the web flow. For example, the server computing device may access and/or modify the state data to reflect the current state of the web flow. The state data may comprise information associated with a control state and/or an extended state. The control state may be associated with one or more resources generated by the client computing device during the web flow. For example, the control state may be used to store information and/or data associated with the particular web page that the client computing device most recently accessed. Further, the extended state may be associated with data submitted by the client computing device and/or retrieved from a remote computing device based on an API interaction associated with the client computing device. For example, the extended state may include information and/or data associated with payment information retrieved from an external source that may be used at a later step of the web flow (when payment is required).

At step 360, the computing device may send and/or transmit one or more responses to the first client computing device. The one or more responses may comprise one or more links (e.g., links to pages) associated with execution of at least one of the one or more steps of the web flow. Further, the one or more links (e.g., pages) may comprise one or more resource links to one or more resources. For example, at the end of each of the one or more steps the server computing device may generate one or more links associated with the next step or steps in the web flow. The server computing device may then send the one or more links to the client computing device, which will present the one or more links as interface options in the user interface of the client computing device. One or more interactions by the client computing device with the one or more links may cause the execution of at least one of the one or more steps. Further, the at least one step comprises either sending a request to end the session or sending a request to perform another step to the server computing device.

At step 370, the computing device may determine whether an end condition (e.g., one of the end conditions described at the step 330) has been satisfied. If the end condition has been satisfied, the method 300 may proceed to the step 390. For example, the step 380 may continue to step 390 if the client computing device sent a request to end the session. If the end condition has not been satisfied, the method 300 may return to the step 330 and the session may continue.

At step 380, a computing device may end or pause the session. Ending or pausing the session may be based at least in part on any of the end conditions described at the step 330. In some embodiments, ending or pausing the session may result in the deletion of state data associated with the session. In other embodiments, ending or pausing the session may result in the state data being stored after the session has ended or been paused.

By automating the execution of a web flow based on a flow model, the disclosed technology allows for a reduction in the amount of burdensome manual customization that may be needed. Further, the web flows may be validated using an API policy that allows for less wastage of computational resources due to maintaining unnecessary dependencies.

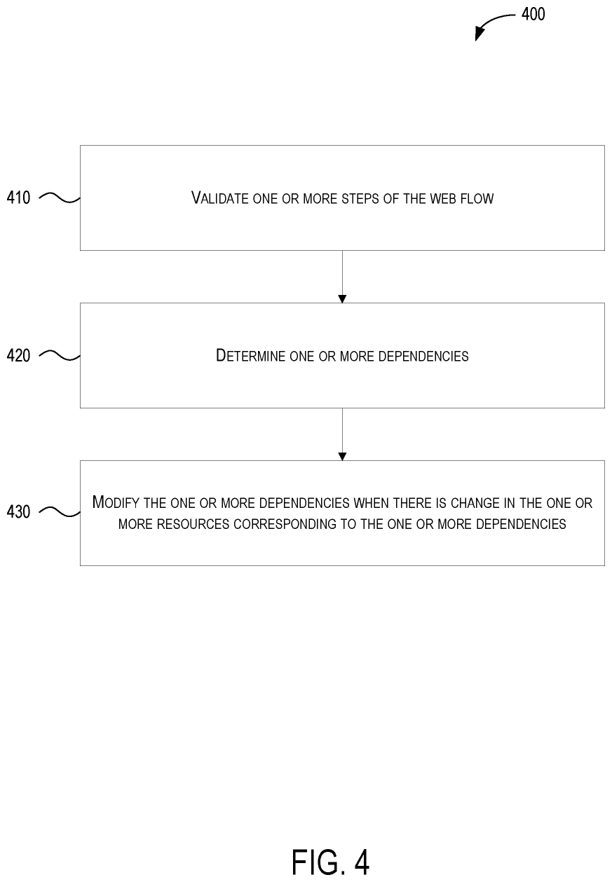

When executing a session associated with a web flow, validating the steps of the web flow and modifying dependencies associated with resources may reduce the incidence of errors that may disrupt the session. FIG. 4 illustrates an example of a method for automatically validating a web flow according to one or more aspects of the disclosure. The method 400 may be implemented by a computing system and/or computing device including any of the computing systems and/or computing devices that are described herein. For example, one or more steps and/or one or more portions of the method illustrated in FIG. 3 may be implemented by the computing device 104 that is illustrated in FIG. 1 and/or the computing device 200 that is illustrated in FIG. 2. Further, the method illustrated in FIG. 3 may be implemented by instructions that are executed by a computing system and/or computing device.

At step 410, a computing device (e.g., a server) may validate the one or more steps of the web flow. Validating the one or more steps of the web flow may be based at least in part on an API policy. For example, validating the one or more steps of the web flow may comprise determining whether each of the one or more steps of the web flow is in an order that is in accordance with a flow order set forth by the API policy. The computing device 104 may be a server computing device that, for each of the one or more steps of the web flow, accesses an API policy that ensures that the one or more steps of the web flow do not deviate from the order established by the API policy. The API policy may include one or more rules that determine one or more operations that may be performed (e.g., performed by the client computing device) and/or one or more resources that may be accessed (e.g., accessed by the client computing device). For example, the API policy may limit a request to perform an action associated with purchasing a product at a particular step before a step associated with selecting a payment method has been performed. The determination of whether a necessary preceding step has been performed may be based at least in part on accessing state data that includes a history of the one or more steps of the web flow that were previously performed. Enforcement of the API policy may be performed by the server computing device.

At step 420, the computing device may determine one or more dependencies associated with one or more resources that are accessed when the one or more steps are executed. For example, the server computing device may access the state data to determine the one or more resources that are being used by the client computing device and/or the one or more resources that are available for use by the client computing device.

At step 430, a computing device may update, modify, and/or adjust the one or more dependencies when there is a change in the one or more resources corresponding to the one or more dependencies. Modifying the one or more dependencies may comprise adding one or more dependencies when the one or more resources corresponding to the one or more dependencies are added and/or deleting one or more dependencies when the one or more resources corresponding to the one or more dependencies are deleted. For example, the one or more resources may include information associated with the smartphone plan of a user. If a user switches from an upper tier plan with more add-on options to a lower tier plan, the server computing device may modify the dependencies between the smartphone plan and the add-ons by removing any of the add-ons that were available in the upper-tier plan that are not available in the lower tier plan.

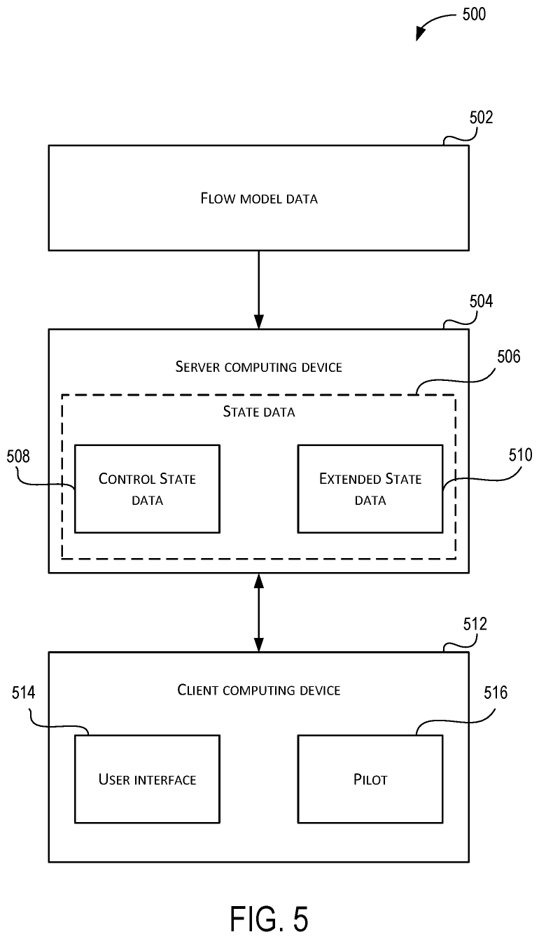

FIG. 5 illustrates an example of an automatic web flow system according to one or more aspects of the disclosure. Any of the operations described as being executed by the automatic web flow system may be performed by any of the computing systems and/or computing devices that are described herein. Further, any of the operations performed by the automatic web flow system may be performed by a computing system and/or computing device that includes one or more features and/or capabilities of the computing systems and/or computing devices that are described herein.

The web flow system 500 may comprise flow model data 502, a server computing device 504, and a client computing device 512. The server computing device 504 may comprise state data 506, including, for example, control state data 508 and extended state data 510. The client computing device 512 may comprise a user interface 514 and/or a pilot 516.

The flow model data 502 may include information and/or data associated with a flow model that describes one or more steps of a web flow. The web flow may be associated with a user journey in which the user interacts with a user interface 514 of an application (e.g., a web browser, a mobile app, etc.) to perform one or more steps of an activity, such as an online purchase or applying for a service via an online interface. The flow model may be represented as a graph (e.g., a directed graph, a directed acyclic graph (DAG), or the like) in which the nodes of the graph represent some type of interaction. For example, the nodes of the graph may represent an API interaction with a client computing device 512 and/or a control element of a user interface 514 that is operated on the client computing device 512. Further, the edges of the graph may represent a sequence in which an API associated with the interaction is called. For example, the interactions of the flow model may include a user's interaction with a user interface 514 in which the interaction results in an application (e.g., a web-based application, a mobile app, etc.) that is running on the client computing device 512 to submit a request to an API (e.g., an API associated with accessing some resource).

The flow model data 502 may define a directional flow in which the one or more steps of the web flow proceed in a particular direction. However, the flow model may support arbitrary flow cycles with different entry and/or exit points using components including menus, breadcrumbs, and/or back buttons. These arbitrary flow cycles are not necessarily defined in the flow and may be based in part on navigational resources of the client computing device 512. The server computing device 504 may support the navigational resources of the client computing device 512 by maintaining a history of the times the resources were used by the client computing device 512 during a session. The sequence by which the flow model is traversed may be conditional and the edge of the graph may be associated with a conditional expression. For example, if a node of the graph (e.g., a node corresponding to a control element of a user interface 514) has multiple options that may lead to different nodes, a conditional expression (e.g., if the user performs a first interaction a first API will be called and if the user performs a second interaction a second API will be called). In some embodiments, the sequence in which the flow model is traversed may be based in part on a weight that is assigned to each of the interactions. In this way, a preferred, more heavily weighted, path through the flow model may be provided. The API interactions may be associated with activities including one or more business rules, one or more API functions, and/or communication with one or more remote computing devices and/or computing systems.

The control elements may include a start element, an exclusive choice element, a multiple-choice element, a merge element, and/or an end element. The exclusive choice element may be used when the client computing device 512 has only one way of proceeding to the next step of the web flow. For example, the exclusive choice may include a control element in which the user may either proceed or cancel the current step. The multiple-choice element may be used when the client computing device 512 provides the user with the option of proceeding to multiple different steps. The multiple-choice element may be paired with the merge element, which activates the next sequence in the flow once the expression defined by the merge element evaluates to true. The end element may be used in a non-cyclic web flow that is not open-ended.

The flow model data 502 may be processed and/or executed on the server computing device 504. In some embodiments, the nodes of the flow model that are not control elements may be associated with resources. The server computing device 504 may maintain state data 506 that is associated with the state of a session involving the server computing device 504 and the client computing device 512. The state data 506 may include control state data 508 and/or extended state data 510. The control state data 508 may include information associated with one or more resources created by the client computing device 512 while the flow model is being traversed. Further, the control state data 508 may include information associated with what part of the flow model the client computing device 512 is using at a given time.

The extended state data 510 may include information associated with data that was submitted by the client computing device 512 and/or data that was retrieved from an external source as a result of a client computing device 512 interaction with the API. The extended state data 510 may also act as a cache for data that is used at a subsequent step of the web flow without additional requests for the client computing device 512 to provide the data.

The server computing device 504 may validate the steps of the web flow that are performed by the client computing device 512 and evaluate the potential next steps of the web flow before providing the potential next steps to the client computing device 512. In some embodiments, an HTTP method may be used to validate and/or process requests by the client computing device 512. For example, during a session, the client computing device 512 may send a POST request associated with a request by the client computing device 512 to advance to a next step of the web flow. After receiving the POST request the server computing device 504 may add a resource to the control state data 508. Further, during a session the client computing device 512 may send a PUT request associated with a request to update the state of a resource created at an earlier step of the web flow. The server computing device 504 may then add the resource to the history but not the control state data 508. Further, during a session the client computing device 512 may send a DELETE request associated with a request to synchronize the control state data 508 with the state of the client when, for example, a control element to cancel an operation has been interacted with. The server computing device 504 may then delete the resource from the control state data 508 but not the history. Further, during a session the client computing device 512 may send a GET request that is associated with retrieving the state of a resource created at an earlier step of the web flow. Requests that are determined to be invalid may result in pausing and/or stopping the session and sending an error message.

In some embodiments, the server computing device 504 may be configured to invalidate one or more steps of the web flow after a resource has been updated or deleted. To invalidate one or more steps of the web flow, the server computing device 504 may change the relationship between resources and the associated dependencies. For example, when a resource is deleted or modified, the dependent resources may be deleted from the control state data 508 and the data mapped to these resources may also be deleted. At any point during the web flow, the server computing device 504 may determine the potential steps that are available to the client computing device 512 by accessing the state data 506 associated with the control state data 508 to determine what step of the web flow the client computing device 512 is at and using the extended state data 510 to evaluate the conditions of the current step including the potential steps that are available. In some embodiments, the potential steps may be weighted and the steps that are available to the client computing device 512 may be prioritized based at least in part on this weighting.

The server computing device 504 may provide the next steps of the web flow to the client computing device 512 in the form of one or more links to resources (HREFS) from which the client computing device 512 may use the user interface 514 to select a step to continue execution of the session. The one or more links may be constrained by an API policy that is enforced by the server computing device 504 and may determine the one or more links that may be provided to the client computing device 512 based at least in part on criteria established by the API policy.

In some embodiments, the client computing device 512 may include the pilot 516. The pilot 516 may be a software application that is configured to perform one or more operations to constrain the one or more links that are provided via the user interface 514 or automatically follow a link. For example, the pilot 516 can automatically cause a particular link to be followed without an interaction by the client computing device 512. By way of further example, the pilot 516 may execute a debug mode in which links that are otherwise limited by the API policy may be presented via the user interface 514.

FIG. 6 illustrates an example of a linear web flow according to one or more aspects of the disclosure. Any of the operations described as part of web flow session 600 may be performed by any of the computing systems and/or computing devices that are described herein. Further, any of the operations described as part of the web flow session 600 may be performed by a computing system and/or computing device that includes one or more features and/or capabilities of the computing systems and/or computing devices that are described herein.

The web flow session 600 may be a session that is initiated between a client computing device (e.g., a laptop computing device) and a server computing device that exchanges (e.g., sends and receives) information and/or data with the client computing device via a network. The web flow session 600 may include steps that are associated with API calls resulting from user interactions with one or more links provided by a server computing device to the client computing device via a user interface of the client computing device. As shown, the web flow session 600 is a linear flow session in which each step of the web flow is followed by a subsequent step until the session concludes. As each step of the web flow is traversed, state data may be generated and/or updated to reflect the current state of the session and/or maintain a history of previous steps that were traversed. Further, in the web flow session 600, the steps of the session do not return to a previous step.

As shown in FIG. 6, the web flow session 600 is associated with the final steps of a user's online purchase of a smartphone using a web browser of a client computing device. The user may interact with a user interface of the web browser and the interactions may cause a request to be sent to a server computing device that executes the step and/or provides links for execution of the next step in the web flow. In a first step 602, the server computing device may receive a request, from the client computing device, to add a smart phone to a shopping cart. The request to add the smart phone to the shopping cart may be based on an interaction with a control element of a user interface that is operating on the client computing device. The server computing device may update the state data to show the smart phone in a shopping cart. After updating the state data, web flow session 600 may advance to a second step 604. In the second step 604, the server computing device may generate one or more links for the next step of the web flow. As shown in FIG. 6, second step 604 causes the one or more links associated with the selection of a payment method to be displayed by the client computing device. As part of the second step 604, the server computing device may receive a selection of a payment method from the client computing device. The selection of the payment method may be based on a user's interaction with one or more elements of the user interface. In response to receiving the selection of the payment method, the server computing device may update state information associated with the web flow session 600 and advance the web flow session 600 to the next step. In a third step 606, the server computing device may cause a confirmation of the payment details to be displayed by the client computing device. The payment details may include product information, billing information, shipping information, etc. The confirmation of the payment details may also comprise a user interaction element that requests that the user confirm the order. In response to receiving a selection of the confirmation of the order, the web flow session 600 may advance to the next, and final step. In a fourth step 608, the smart phone may be purchased. Accordingly, the server computing device may update state information reflecting the purchase. Additionally or alternatively, the server computing device may cause purchase confirmation information to be displayed on the client computing device.

The process described above illustrates an example of a linear web flow session according to one or more aspects of the disclosure. The linear web flow session process shown in FIG. 6 ensures that links are displayed in the correct order and that the web flow, and purchase, occur smoothly and effortlessly.

FIG. 7 illustrates an example of a non-linear web flow according to one or more aspects of the disclosure. Any of the operations described as part of web flow session 700 may be performed by any of the computing systems and/or computing devices that are described herein. Further, any of the operations described as part of the web flow session 700 may be performed by a computing system and/or computing device that includes one or more features and/or capabilities of the computing systems and/or computing devices that are described herein. As shown, the web flow session 700 is a non-linear flow session in which some of the steps of the session may lead to more than one subsequent step. Further, some portions of the web flow in the web flow session 700 may be cyclic and may be performed an indefinite number of times or a number of times that is constrained by some predetermined threshold.

As shown in FIG. 7, the web flow session 700 may be associated with a user's online purchase of a smartphone plan using a web browser of a client computing device. The user may interact with a user interface of a web browser and the interactions with the user interface may cause a request to be sent to a server computing device that executes the steps and/or provides links for execution of the next steps in the web flow. The web flow session 700 may include steps that are associated with API calls resulting from user interactions with one or more links provided by a server computing device to the client computing device via the user interface of a web browser that operates on the client computing device. Further, state data including information associated with the history of the web flow and/or the current position within the web flow may be generated and/or modified based at least in part on the interactions.

At a step 702, a user logs into their account, which will cause the server computing device to access stored user account data (e.g., the user's current phone plan and payment information) that may be used in subsequent steps of the web flow session 700. The step 702 may be followed by the one or more sub-steps 704 an indefinite number of times. The sub-steps 704 may prompt the user to switch to another user account. Based on the user interactions at 702, the server computing device may provide links to the one or more sub-steps 704 and/or links to step 706, which may prompt the user to select a smartphone plan.

At the step 706, the client computing device may perform an interaction associated with the selection of a smartphone plan (e.g., select from different smartphone plans including different transfer speeds or data limits). Based on selecting a smartphone plan, the server computing device may provide the client computing device with one or more options. The one or more options may be associated with links to different pages. For example, the server computing device may cause several options to be displayed on the client computing device. These options may include the option to: include add-ons to their plan (e.g., step 708), select a smartphone (e.g., step 710), or purchase the plan (e.g., step 714).

If the user selects to include add-ons to their plan, the web flow session 700 may proceed to step 708. In step 708, the server computing device may cause one or more plan add-ons to be displayed by the client computing device. The client computing device may interact with and/or select one or more plan add-ons (e.g., adding an unlimited international calling feature) to the selected smartphone plan. The state data may be updated to reflect the user's selections, for example, at each step.

If the user selects to purchase a smartphone, the web flow session 700 may proceed to step 710, the server computing device may cause one or more mobile devices (e.g., smartphones, tablets, etc.) to be displayed by the client computing device. The client computing device may interact with and/or select a mobile device to purchase. As noted above, the state data may be updated to reflect the user's selections at this step, as well. Step 710 may provide additional options, such as configuring the mobile device (e.g., step 712) or purchasing the plan and/or mobile device (e.g., step 714).

If the user selects to configure the mobile device, the web flow session 700 may proceed to step 712. In step 712, the server computing device may cause one or more configuration pages to be displayed by the client computing device. The client computing device may interact with and/or select one or more configurations for their mobile device.

When the user has finalized their order, the web flow session 700 may proceed to step 714, where the server computing device may cause a purchase page to be displayed on the client computing device. As noted above in FIG. 6, this may step through another web flow of links and/or pages that allow the user to complete the purchase of the smartphone plan and/or mobile device.

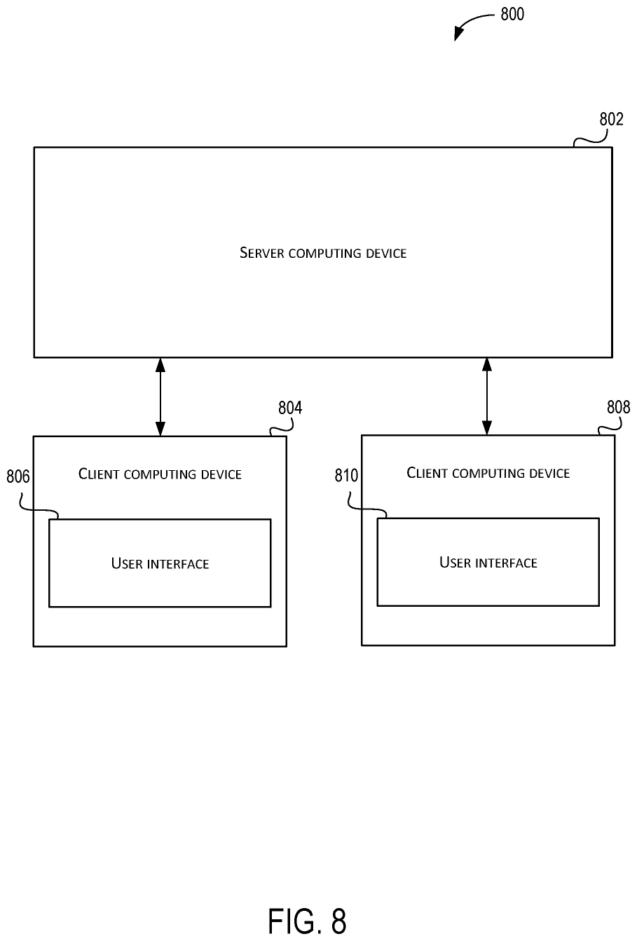

FIG. 8 illustrates an example of server computing device interactions with multiple client computing devices according to one or more aspects of the disclosure. Any of the operations described as being performed by the web flow system 800 may be performed by any of the computing systems and/or computing devices that are described herein. Further, any of the operations described as being performed by the web flow system 800 may be performed by a computing system and/or computing device that includes one or more features and/or capabilities of the computing systems and/or computing devices that are described herein.

The web flow system 800 may comprise a server computing device 802, a first client computing device 804, and a second client computing device 808. The first client computing device 804 comprises a first user interface 805; the second client computing device 808 comprises a second user interface 810.

The server computing device 802 may include flow model data associated with a flow model that models a web flow (e.g., a web flow associated with a customer journey through a set of web pages). In this example, the server computing device 802 is executing the steps of a session for a web flow in which a first user of the first client computing device 804 (e.g., a laptop computing device) interacts with the first user interface 806 and a second user of the second client computing device 808 (e.g., a smartphone), which is a different type of device from the first client computing device 804, interacts with the second user interface 810, which is a different user interface from the first user interface 806.

The first user interface 806 generated on the first client computing device 804 includes interface elements that are arranged in a different manner from the interface elements of the second user interface 810. For example, the first user interface 806 may include interface elements that are arranged to accommodate the wider horizontal aspect ratio of the first client computing device 804. In comparison, the second user interface 810 may include interface elements that are arranged to accommodate the taller vertical aspect ratio of the second client computing device 808. Further, the first user interface 806 may include interface elements that accommodate interactions that are provided by a pointing device (e.g., an onscreen pointer controlled by a mouse) while the second user interface 810 may include interface elements that have a different size and shape to accommodate interactions via a touch interface.

The interaction between the server computing device 802 and the client computing devices (e.g., the first client computing device 804 and the second client computing device 808) includes the execution of a session for a web flow that is initiated by the client computing device. Each step of the web flow may be executed by the server computing device 802 based on flow model data that is determined by the type of web flow for the session requested by the client computing devices. In this example, the first client computing device 804 and the second client computing device may be traversing the same web flow (based on the same model data) which is executed by the server computing device 802 which provides the first client computing device 804 and the second client computing device 808 with a set of links at each step of the web flow.

Though the web flows on the first client computing device 804 and the second client computing device 808 may be based on the same flow model data, the steps of the web flows may be represented differently due to the differences in the way the first user interface 806 and the second user interface 810 implement the steps of the web flows. Certain steps of the web flow presented on the first user interface 806 may not be presented or may be presented differently on the second user interface 810 due to the smaller size and resulting space limitations of the second user interface 810. For example, a menu bar that includes six (6) visible options on the first user interface 806 may be represented as a menu bar button that upon being interacted with may be expanded to present the six (6) options that are always visible in the second user interface 810.

Although the subject matter of the present disclosure has been described in language specific to structural features and/or methodological acts, it is to be understood that the subject matter defined in the claims is not necessarily limited to the specific features or acts described herein. Rather, the specific features and operations described herein are disclosed as example implementations of the claims. The steps of any methods described herein are described as being performed in a particular order for the purposes of discussion. A person having ordinary skill in the art will understand that the steps of any methods discussed herein may be performed in any order and that any of the steps may be modified, omitted, combined, and/or expanded without departing from the scope of the present disclosure. Furthermore, the methods described herein may be performed using any manner of system, device, apparatus, and/or non-transitory computer-readable media.

What is claimed is:

1. A method comprising:
accessing, by a server computing device, flow model data comprising information associated with one or more steps of a web flow;
mapping, by the server computing device and based at least in part on the flow model data, the one or more steps of the web flow to one or more application programming interface (API) interactions with a client computing device;
receiving, by the server computing device and from a first client computing device, one or more requests during a session associated with the one or more steps of the web flow, wherein the one or more requests are based at least in part on the one or more API interactions;
accessing, by the server computing device, one or more resources associated with the one or more requests;
updating, by the server computing device, state data associated with the one or more resources requested by the first client computing device during the web flow; and
sending, by the server computing device and to the first client computing device, one or more responses comprising one or more links associated with execution of at least one of the one or more steps of the web flow.

2. The method of claim 1, wherein the one or more API interactions comprise an interaction with the one or more links that request execution of a first step of the one or more steps, and wherein the first step comprises at least one of: a request to end the session or a request to perform another step.

3. The method of claim 1, wherein the one or more API interactions comprise at least one of: execution of a business rule, calling an API function, or communicating with a remote computing device.

4. The method of claim 1, wherein the one or more API interactions comprise one or more control element interactions of a user interface of the first client computing device.

5. The method of claim 4, wherein the one or more control element interactions comprise at least one of: one or more exclusive choice element interactions or one or more multiple choice element interactions.

6. The method of claim 1, wherein the web flow is associated with navigation of one or more web pages via a user interface implemented by the first client computing device.

7. The method of claim 1, further comprising:
validating, by the server computing device, the one or more steps of the web flow based at least in part on an API policy.

8. The method of claim 7, wherein the validating the one or more steps of the web flow comprises determining, by the server computing device, whether each of the one or more steps of the web flow is in an order that is in accordance with a flow order set forth by the API policy.

9. The method of claim 1, further comprising:
determining, by the server computing device, one or more dependencies associated with one or more resources that are accessed when the one or more steps are executed; and
modifying, by the server computing device, the one or more dependencies when there is a change in the one or more resources corresponding to the one or more dependencies.

10. The method of claim 9, wherein the modifying the one or more dependencies comprises adding one or more dependencies when the one or more resources corresponding to the one or more dependencies are added or deleting one or more dependencies when the one or more resources corresponding to the one or more dependencies are deleted.

11. The method of claim 1, wherein the one or more steps of the web flow are arranged in a linear flow in which each step of the web flow is associated with one or more steps defined by the flow model data, and wherein the one or more steps are in accordance with an API policy.

12. The method of claim 1, wherein the one or more requests comprise at least one of: a request to advance to a next step of the web flow, a request to update a state of the one or more resources used in a previous step of the web flow, a request to update a state of one or more resources used in a previous step of the web flow, or a request to retrieve the state of one or more resources used in a previous step of the web flow.

13. The method of claim 1, wherein execution of the one or more steps of the web flow is initiated by the server computing device in response to receiving a request to initiate a web flow session from the first client computing device.

14. The method of claim 1, wherein the state data comprises information associated with:
a control state associated with the one or more resources accessed by the first client computing device during the web flow; or
an extended state associated with data submitted by the first client computing device or retrieved from a remote computing device based on an API interaction by the first client computing device.

15. One or more non-transitory computer readable media comprising instructions that, when executed by at least one processor, cause a computing device to perform operations comprising:
accessing flow model data comprising information associated with one or more steps of a web flow;
mapping, based at least in part on the flow model data, the one or more steps of the web flow to one or more application programming interface (API) interactions with a client computing device;
receiving from a first client computing device, one or more requests during a session associated with the one or more steps of the web flow, wherein the one or more requests are based at least in part on the one or more API interactions;
accessing one or more resources associated with the one or more requests;
updating state data associated with the one or more resources requested by the first client computing device during the web flow; and
sending to the first client computing device, one or more responses comprising one or more links associated with execution of at least one of the one or more steps of the web flow.

16. The one or more non-transitory computer readable media of claim 15, wherein the one or more steps of the web flow are executed until an end condition associated with ending the web flow is satisfied.

17. The one or more non-transitory computer readable media of claim 16, wherein satisfying the end condition comprises the client computing device sending a request to end the web flow, a predetermined amount of time elapsing without receiving a request from the client computing device, or the execution of a final step of the one or more steps of the web flow.

18. A computing device comprising:
one or more processors; and
memory storing instructions that, when executed by the one or more processors, cause the computing device to:
access flow model data comprising information associated with one or more steps of a web flow;
map, based at least in part on the flow model data, the one or more steps of the web flow to one or more application programming interface (API) interactions with a client computing device;
receive from a first client computing device, one or more requests during a session associated with the one or more steps of the web flow, wherein the one or more requests are based at least in part on the one or more API interactions;
access one or more resources associated with the one or more requests;
update state data associated with the one or more resources requested by the first client computing device during the web flow; and
send to the first client computing device, one or more responses comprising one or more links associated with execution of at least one of the one or more steps of the web flow.

19. The computing device of claim 18, wherein the one or more links comprise one or more resource links to one or more resources.

20. The computing device of claim 18, wherein the web flow is implemented via a web application, and wherein the one or more steps are associated with accessing resources via the web application.
